(19) United States
(12) Patent Application Publication
(10) Pub. No.: US 2007/0295649 A1
(43) Pub. Date: Dec. 27, 2007

(54) Apparatus for Collecting and Transporting Coolant-Lubricant Contaminated with Chips

(75) Inventors: Luc Reynders, Riemst (BE); Jan Kempeneers, Hoeselt (BE)

Correspondence Address: CROWELL & MORING LLP;INTELLECTUAL PROPERTY GROUP, P.O. BOX 14300, WASHINGTON, DC, 20044-4300, US

(73) Assignee: MANN & HUMMEL GMBH, Ludwigsburg (DE)

(21) Appl. No.: 11/743,838

(22) Filed: May 3, 2007

(30) Foreign Application Priority Data
May 3, 2006 (DE) 20 2006 007164.4

(51) Int. Cl. B01D 35/14; B01D 35/00

(52) U.S. Cl. 210/87

(57) ABSTRACT

An apparatus for collecting and transporting chip-contaminated coolant, including a trough-shaped channel arranged underneath or between machine tools and a filter apparatus or a recirculating pump station, with at least one opening being provided in a lower region of the channel. Above this opening is at least one fluid outlet, which is configured such that coolant or another fluid streaming through this opening and the fluid outlet accelerates the transport of liquid and/or solid materials in the channel.

### BACKGROUND OF THE INVENTION

The invention relates to an apparatus for collecting and transporting chip-contaminated coolant.

U.S. Pat. No. 5,980,735 discloses an apparatus for collecting coolant and chips. This apparatus is used to transport the described components from a plurality of machine tools to a filter system in which the coolant is filtered before being recirculated back to the machine tools. Conventionally, channels for collecting the contaminated coolant extend underneath a plurality of machine tools. These channels have a slope or gradient that allows the coolant to flow toward the filter system. If the gradient of these channels is not particularly steep, however, there is a risk that the chips will clog the channel and the fluid will back up.

To prevent this backup, the prior art proposes arranging a plurality of spray nozzles above the channel, which deliver coolant under pressure to flush away any chip agglomerations and also to accelerate the coolant within the channel to ensure rapid removal. A disadvantage of the known apparatus is that the nozzles must be arranged above the maximum fluid level so that the nozzles themselves do not hamper the fluid stream or chip stream. As a result the jet strikes the fluid only on the surface and there is a risk that the components will not be adequately flushed away, particularly if the chips are heavy or if swarf needs to be removed.

### SUMMARY OF THE INVENTION

Accordingly, it was an object of the invention to provide an improved apparatus for collecting and transporting coolant-lubricant contaminated with chips.

Another object of the invention was to overcome the aforementioned disadvantages and provide an apparatus that reliably flushes the coolant and the chips or impurities contained therein to a filter apparatus or a recirculating pump station.

These and other objects have been achieved in accordance with the invention by providing an apparatus for collecting and transporting chip-contaminated coolant, said apparatus comprising a trough-shaped channel arranged underneath or between machine tools, a filter apparatus, and a recirculating pump station; wherein at least one opening is provided in a lower region of the channel, and above this opening there is at least one fluid outlet which is configured such that a coolant or another fluid which flows through this opening and the fluid outlet accelerates the transport of liquid or solid material or both inside the channel.

A substantial advantage of the invention is that openings are provided in the floor of the channel, and the fluid, i.e., the coolant, can be guided through these openings. The openings are arranged in such a way that they accelerate the fluid and the contaminants contained therein in the fluid transport direction, i.e., toward the filter apparatus or the recirculating pump station.

In accordance with one embodiment of the invention, these openings are provided with one or more nozzle heads, which are screwed or welded to the channel.

Preferably, the nozzle heads are flat and have a ramp surface for the fluid stream, so that the nozzle heads interfere as little as possible with the fluid stream.

In accordance with another embodiment of the invention, a plurality of nozzle heads are arranged along the channel, preferably at locations where an increased amount of contamination is introduced or where there is a risk that the fluid stream will slow or stop.

According to a preferred further refinement of the invention, a velocity sensor is provided in the area of the channel or above the channel for measuring the velocity of the fluid within the channel. The fluid flowing through the nozzle head can then be controlled as a function of the measured velocity. The flow velocity of the fluid preferably ranges between 0.1 and 1 meter per second.

In accordance with another advantageous embodiment, the channel is formed of a plurality of sections. These individual sections are flanged together, with a sealing ring being provided in the area of each flanged connection.

In yet another embodiment of the invention, the nozzle heads are arranged in such a way that the flow velocity decreases toward the filter apparatus or recirculating pump station. The first nozzle at the point where the coolant from the first machine tool enters at the beginning of the channel must ensure that the fluid fed into the channel has the maximum possible velocity.

Another substantial advantage of the invention is that the openings embedded within the fluid prevent foaming within the channel.

These and other features of preferred embodiments of the invention, in addition to being set forth in the claims, are also disclosed in the specification and/or the drawings, and the individual features each may be implemented in embodiments of the invention either alone or in the form of subcombinations of two or more features and can be applied to other fields of use and may constitute advantageous, separately protectable constructions for which protection is also claimed.

### BRIEF DESCRIPTION OF THE DRAWINGS

The invention will be described in greater detail hereinafter with reference to illustrative preferred embodiments shown in the accompanying drawing figures, in which:

FIG. 1 is a schematic representation of an installation with a plurality of machine tools and a channel for removing contaminated coolant;

FIG. 2 is a detail view of a nozzle head in a longitudinal section;

FIG. 3 is a longitudinal section of the nozzle head shown in FIG. 2, and

FIG. 4 is a perspective view of a channel with a plurality of nozzle heads arranged therein.

### DETAILED DESCRIPTION OF PREFERRED EMBODIMENTS

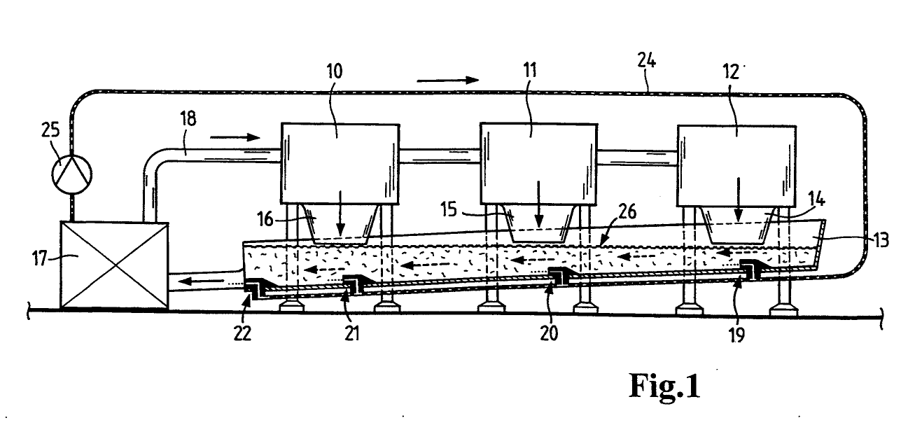

FIG. 1 schematically shows three machine tools 10, 11, 12. Underneath these machine tools extends an apparatus, also referred to as channel 13, for collecting and transporting chip-contaminated coolant. The coolant discharged from the machine tools carrying the chips produced is fed into this channel through suitable funnel-shaped devices 14, 15, 16. The machine tools are supplied with filtered coolant from a filter apparatus 17 through the fluid line 18.

In the channel 13 are nozzle heads 19, 20, 21 and 22, which are arranged in the floor of the channel 13. The nozzle heads are also supplied with fluid, which is removed from the filter apparatus 17 and flows through the line 24. The nozzle heads are located below the fluid level and receive the fluid at a certain fluid pressure via a pump 25. The nozzles are oriented toward the filter apparatus and ensure that the fluid 26 inside the channel 13 flows toward the filter apparatus. As may be seen, the channel has a downward slope or gradient in the direction of the filter apparatus. As a rule, this gradient is kept very small, however, so that a plurality of machine tools can be connected to the channel and the channel at the last machine tool is not excessively high.

The advantage of the nozzle heads is that almost no gradient is required within the channel, since the fluid streaming out of the nozzle heads nevertheless ensures that the flow velocity of the fluid 26 is sufficiently high that the material contained therein, such as chips or swarf, is reliably entrained.

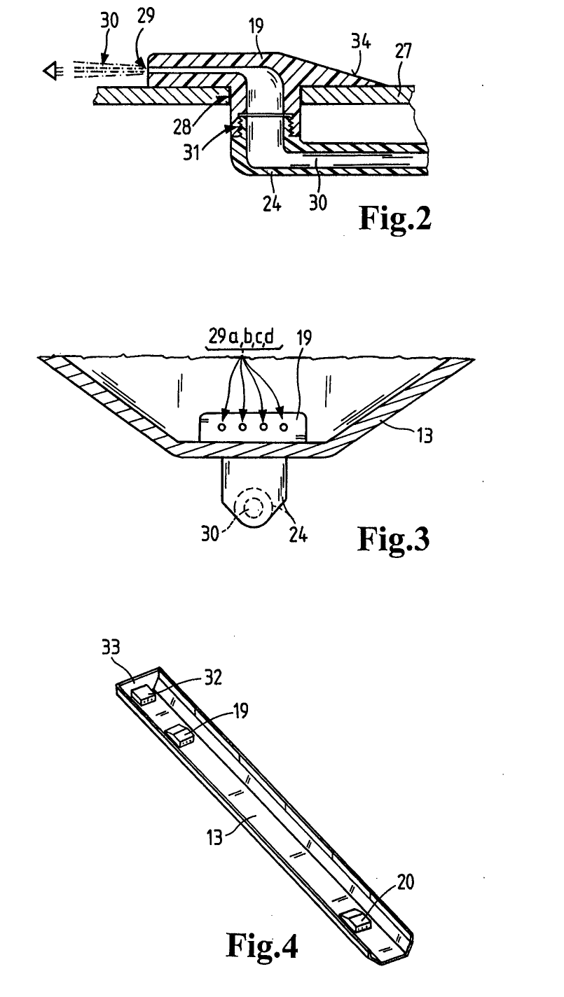

FIG. 2 is a section of a nozzle head 19 taken along the channel. The channel floor 27 has an opening 28, above which the nozzle head is arranged. The nozzle head has a nozzle opening 29 through which the fluid 30 is delivered. The nozzle head 19 has a connection 31 extending through the opening 28 and is connected to the line 24. The nozzle head has an inclined surface to improve the flow of the contaminated fluid over the nozzle head. The inclined surface also prevents dirt or chips from collecting on the nozzle head.

FIG. 3 shows the nozzle head 19 as seen from the nozzle openings 29 (a) through (d). It is useful to equip the nozzle heads with a varying number of nozzle openings along the length of the channel. Of course, the diameter of the nozzle openings may also be varied to optimize flow within the channel.

FIG. 4 is a perspective view of the channel 13 showing a nozzle head 19 and a nozzle head 20. At the beginning of the channel a single nozzle head 32 may be provided in the end wall 33.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof.

What is claimed is:

1. An apparatus for collecting and transporting chip-contaminated coolant, said apparatus comprising a trough-shaped channel arranged underneath or between machine tools, a filter apparatus, and a recirculating pump station; wherein at least one opening is provided in a lower region of the channel, and above this opening there is at least one fluid outlet which is configured such that a coolant or another fluid which flows through this opening and the fluid outlet accelerates the transport of liquid or solid material or both inside the channel.

2. An apparatus according to claim 1, wherein the opening provided in the lower region is equipped with a nozzle head, which is screwed or welded to the channel, and said nozzle head has a plurality of fluid outlet openings.

3. An apparatus according to claim 1, wherein a plurality of spaced apart fluid outlet openings or nozzle heads are distributed along the channel.

4. An apparatus according to claim 1, further comprising at least one velocity sensor provided in the area of the channel for measuring flow velocity inside the channel, and wherein fluid flow through the nozzle head is controlled as a function of the measured flow velocity.

5. An apparatus according to claim 1, wherein the fluid has a flow velocity in the range from 0.1 to 1 meter per second.

6. An apparatus according to claim 1, wherein the channel is assembled from a plurality of sections, and the individual sections are interconnected by a flanged connection, and at least one axially acting sealing ring is provided for each flanged connection to form a seal between interconnected sections.

7. An apparatus according to claim 1, wherein each nozzle head along the channel has a number of individual nozzles adapted to the required flow velocity, and flow in the geodetically upper region of the channel has a flow velocity greater than in the lower region of the channel.
